(19) United States
(12) Patent Application Publication
(10) Pub. No.: US 2009/0230825 A1
(43) Pub. Date: Sep. 17, 2009

(54) Shaft Coupling

(75) Inventors: Matthias Braun, Weichtungen (DE); Winfried Kessler, Hausen (DE); Michael Zisler, Euerdorf-Wirmsthal (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 12/441,846

(22) PCT Filed: Sep. 14, 2007
(86) PCT No.: PCT/EP07/59693

§ 371 Date: Mar. 18, 2009

(30) Foreign Application Priority Data
Sep. 19, 2006 (DE) 10 2006 043 897.3

(51) Int. Cl. H02K 7/10; F16D 3/04

(52) U.S. Cl. 310/75 D; 464/104

(57) ABSTRACT

The invention relates to a shaft coupling for connecting a transmitter (15) to an electrical machine, in particular to an electric motor (16), wherein an end section (5) of a transmitter shaft (6) and an end section (2) of a motor shaft (1) are arranged facing each other, and at least one torque transmission element (9) is arranged between the end sections (5) of the transmitted shaft (6) and the motor shaft (1). The torque transmission element (9) has on each of the front faces thereof a transverse groove (10,11) passing through the center thereof, wherein claw-like elements (3, 4, 7, 8) of the end sections (2, 5) of the motor shaft (1) and the transmitter shaft (6) correspond in the assembled state with the transverse grooves (10,11) of the torque transmission element (9) in such a way that a torque transmission takes place from the motor shaft (1) to the transmitter (15), which compensates both radial and axial offsets as well as angular offsets of the motor and the transmitter shaft. Transverse grooves (10, 11) and claw-like elements (3, 4, 7, 8) of the respective end sections (2, 5) have a type of means that eliminates the possibility of an incorrect assembly of the transmitter shaft (6) onto the torque transmission element (5).

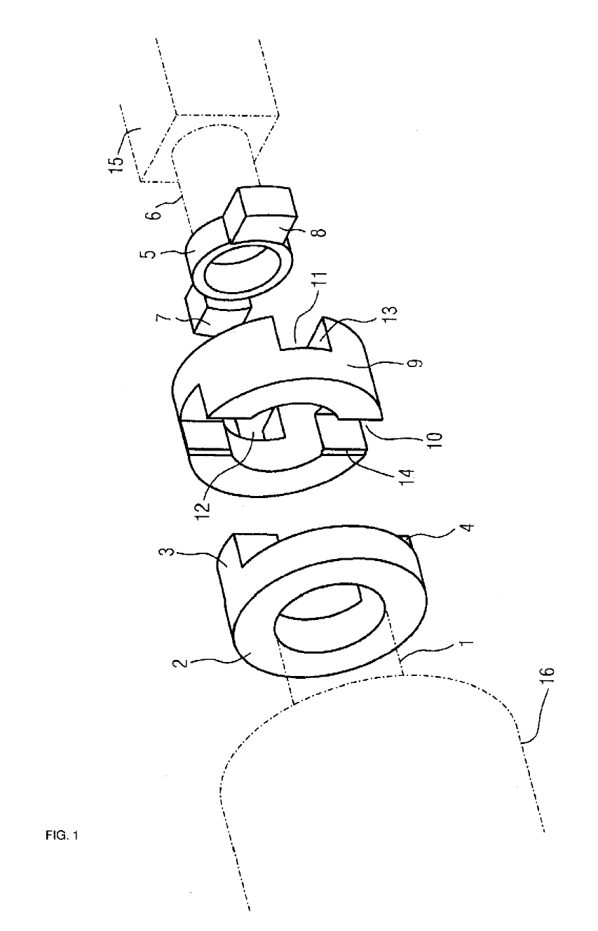

The invention relates to a shaft coupling for coupling a transmitter to an electrical machine, in particular an electric motor.

When using electrical machines with rotating shafts, it is often desirable to detect the rotation speed of the shaft, or the position of the rotor. A wide range of different rotation speed measurement devices exist for this purpose, for example pulse transmitters, tacho-generators etc., and transmitter elements as well.

For example, EP 1 452 759 A1 discloses a shaft coupling which connects a motor shaft to a transmitter shaft.

This has the disadvantage that these known feedback systems, that is to say the couplings to the transmitter, do not ensure that their individual elements are fitted correctly. In some machine types, a 180° offset of the elements to be coupled results in possible errors leading to incorrect positioning, for example of an electric motor of a process machine.

Against this background, the invention is based on the object of providing a shaft coupling which cannot be fitted incorrectly, and in particular whose individual elements cannot be fitted incorrectly.

The stated object is achieved by a shaft coupling for coupling a transmitter to an electrical machine, in particular to an electric motor, with an end section of a transmitter shaft and an end section of a motor shaft being arranged opposite, and with at least one torque transmission element being arranged between the end sections of the transmitter shaft and the motor shaft, with the torque transmission element having a transverse groove which runs through its center point, on each of its end faces, with claw-like elements of the end sections of the motor shaft and of the transmitter shaft corresponding with the transverse grooves in the torque transmission element in the assembled state such that torque is transmitted from the motor shaft to the transmitter, which torque transmission compensates for both the radial and axial offsets as well as the angle offsets of the motor shaft and transmitter shaft, with transverse grooves and claw-like elements of the respective end sections having means such that incorrect fitting of the transmitter shaft to the torque transmission element is precluded.

According to the invention, this allows the shaft to be coupled to be installed with a comparatively short axial separation.

The present coupling according to the invention is based on the principle of the Oldham coupling (cross-slide coupling). These couplings are most suitable for use as shaft couplings in terms of stiffness, in particular torsional stiffness, and freedom of play. However, the solution which is now proposed according to the invention ensures that this coupling is fitted correctly during assembly. The angular position of the end section of the transmitter shaft can therefore be set securely in all cases. The end sections of the motor shaft and of the transmitter shaft are preferably composed of metal, and the torque transmission element is provided with transverse grooves and can be formed, at least in places, as a plastic part.

The contours of the end sections are advantageously incorporated directly in the shaft ends of the electric motor and/or of the transmitter.

In a further advantageous refinement, the two arms of the transverse grooves which are opposite the end section of the transmitter shaft are designed to have a different width and/or depth, thus ensuring that they cannot be fitted incorrectly to the end section of the transmitter shaft. The torque transmitter element can therefore be fitted to the end section of the transmitter shaft in only a single angular position. The groove depth is in this case matched to the groove width such that this ensures mass compensation, and thus there are no unbalances influencing the detection accuracy of the transmitter.

Furthermore, taking into account the requirements mentioned above, the arms of the transverse grooves may also have a different shape, with the advantages as mentioned above that they cannot be fitted incorrectly. In this case, for example, one arm is provided with a cuboid contour, and the other arm with a droplet-shaped contour.

Appropriately modified plastics are used in order to increase the life of the torque transmission element. In this case, thermoplastics, preferably provided with carbon fibers or glass fibers, are particularly suitable in order to increase the stiffness and to reduce and/or to stabilize the thermal coefficient of expansion.

In order to reduce the coefficients of friction, lubricants such as PTFE or the like are in this case added to the plastic. Special shaping of the plastic part ensures that the coupling has no play. By way of example, this is achieved by designing the plugged-together parts to be oversized, thus resulting in an interference fit.

In one advantageous refinement, the groove geometry is designed to be slightly larger at the groove base than in the upper area (conical groove). This ensures that the flanks of the transverse groove rest over a large area on the claw-like element, when the shaft coupling is assembled.

This ensures constant, oscillation-free torque transmission from the motor shaft to the transmitter over the entire operating range (relating inter alia to temperature and rotation speed).

In further embodiments of the invention, markings are provided on the end sections of the identical claw-like elements in order in this way likewise to ensure that the shaft coupling cannot be fitted incorrectly. In this case, protection against incorrect fitting is ensured by visual inspection.

The invention and further advantageous refinements of the invention will be explained in more detail with reference to an illustrated exemplary embodiment.

The FIGURE shows an end section 2 of a motor shaft 1 of a motor 16, which is not illustrated in any more detail, which end section 2 has claw-like elements 3, 4. The FIGURE also shows an end section 5 of a transmitter shaft 6 of a transmitter 15 which is not illustrated in any more detail, whose end section 5 likewise has claw-like elements 7, 8.

The FIGURE furthermore shows an essentially cylindrical torque transmission element 9 with transverse grooves 10, 11 which are arranged on the end faces and run at right angles to one another, in which the claw-like elements 3, 4, 7, 8 of the respective end sections 2, 5 of the motor shaft 1 and transmitter shaft 6 engage. The individual claw-like elements 3, 4, 7, 8, in particular the claw-like elements 7, 8 on the transmitter side, are in this case designed such that they can be fitted directly to the sections of the transverse grooves 10, 11, in particular only to the transverse groove 11.

In this case, the individual arms 12, 13 of the transverse groove 11 are designed such that the end section 5, with its claw-like elements 7, 8, can be fitted only in the specified position.

It is therefore impossible to fit an end section 5 rotated through 180° of the transmitter shaft 6. 100% protection is therefore provided against the individual elements of the shaft coupling being fitted incorrectly. The invention also allows the individual elements to be fitted blind, with blind fitting being fitting in which the parts to be fitted do not need to be accessible in the position in which they are to be fitted, for example in order to check fitting by inspection.

The claw-like elements 7, 8 are therefore designed differently such that they can be fitted to the differently designed arms 12, 13 of the transverse groove 11 in only one predetermined position, thus allowing the rotation speed and/or rotation angle and/or position of the motor shaft 1 to be transmitted correctly.

The motor shaft 1 and transmitter shaft 6 are connected to their respective end sections 2, 5 by suitable transmission means, for example adjusting springs. Alternatively, the end sections 2, 5 form a single-piece unit with their shafts, and are thus composed of one material such that there is no need for special transmission means from the shafts to their respective end sections 2, 5. The contours of the end sections 2, 5 are therefore incorporated directly in the ends of the motor shaft 1 and/or of the transmitter shaft 6.

Furthermore, the end sections 2, 5 can be injection molded into or sprayed onto the shaft of the electric motor 16 and/or transmitter 6. Suitable possible geometric shapes are, for example, multi-tooth or polyhedral geometries.

In order to prevent a shaft coupling such as this from being fitted incorrectly, it is also possible for there to be visual markings on the claw-like elements 7, 8 and the associated arms 12, 13, which are in the form of paint markings, notches, dots or other visual features.

The fundamental idea according to the invention of ensuring that a shaft coupling cannot be fitted incorrectly can be applied to other shaft couplings with a plurality of transverse grooves and/or radially running grooves on the torque transmission element 9.

The invention is not restricted to shaft couplings with just one torque transmission element, and a plurality of torque transmission elements 9 are likewise feasible which are arranged axially one behind the other and engage in one another. In this case, the junction to the respective shaft ends is designed according to the invention.

The shaft coupling according to the invention is preferably used, inter alia, in machine tools, printing machines, robots, textile machines and carpentry machines, in order to transmit torque without any oscillations and with comparatively high damping to the transmitter.

1.-6. (canceled)

7. A shaft coupling for coupling a transmitter to an electrical machine, said shaft coupling comprising:
a first end section formed on a transmitter shaft and having claw-like elements on opposite sides of the first end section;
a second end section formed on a motor shaft in opposite relationship to the first end section and having claw-like elements; and
at least one torque transmission element arranged between the first and second end sections and having opposite end faces, each including a transverse groove extending through a center point of the torque transmission element, with the claw-like elements of the first end section corresponding with the transverse groove on one of the end faces of the torque transmission element, and with the claw-like elements of the second end section corresponding with the transverse groove on the other one of the end faces of the torque transmission element so that in an assembled state torque is transmitted from the motor shaft to the transmitter to compensate radial and axial offsets as well as an angle offset of the motor shaft and transmitter shaft, with the transverse grooves of the torque transmission element and the claw-like elements of the first and second end sections being constructed to preclude an incorrect fitting of the transmitter shaft to the torque transmission element,
wherein the claw-like elements of the first end section have different configuration so as to fit in an interlocking manner in the transverse groove on the one end face of the torque transmission element only in a predefined orientation.

8. The shaft coupling of claim 7, wherein the transverse grooves on the torque transmission element are arranged at a right angle to one another.

9. The shaft coupling of claim 7, further comprising markings on the torque transmission element and on the first end section.

10. The shaft coupling of claim 7, wherein the first end section is connected in one piece with the transmitter shaft and the second section is connected in one piece with the motor shaft.

11. The shaft coupling of claim 7, wherein the electric machine is an electric motor.

12. An electric machine, comprising:
a motor shaft;
a transmitter shaft; and
a shaft coupling for coupling the motor shaft to the transmitter shaft, said shaft coupling including:
a first end section formed on the transmitter shaft and having claw-like elements on opposite sides of the first end section,
a second end section formed on the motor shaft in opposite relationship to the first end section and having claw-like elements, and
at least one torque transmission element arranged between the first and second end sections and having opposite end faces, each including a transverse groove extending through a center point of the torque transmission element, with the claw-like elements of the first end section corresponding with the transverse groove on one of the end faces of the torque transmission element, and with the claw-like elements of the second end section corresponding with the transverse groove on the other one of the end faces of the torque transmission element so that in an assembled state torque is transmitted from the motor shaft to the transmitter to compensate radial and axial offsets as well as an angle offset of the motor shaft and transmitter shaft, with the transverse grooves of the torque transmission element and the claw-like elements of the first and second end sections being constructed to preclude an incorrect fitting of the transmitter shaft to the torque transmission element,
wherein the claw-like elements of the first end section have different configuration so as to fit in an interlocking manner in the transverse groove on the one end face of the torque transmission element only in a predefined orientation.

13. The electric machine of claim 12, wherein the transverse grooves on the torque transmission element are arranged at a right angle to one another.

14. The electric machine of claim 12, further comprising markings on the torque transmission element and on the first end section.

15. The electric machine of claim 12, wherein the first end section is connected in one piece with the transmitter shaft and the second section is connected in one piece with the motor shaft.
